(19) United States
(12) Patent Application Publication
(10) Pub. No.: US 2008/0123040 A1
(43) Pub. Date: May 29, 2008

(54) Liquid crystal display device and manufacturing method of the same

(75) Inventors: Sung-hoon Yang, Gyeonggi-do (KR); So-woon Kim, Gyeonggi-do (KR); Chong-chul Chai, Seoul (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 11/985,838

(22) Filed: Nov. 16, 2007

(30) Foreign Application Priority Data
Nov. 23, 2006 (KR) 10-2006-0116531

(51) Int. Cl. G02F 1/1345; G02F 1/13

(52) U.S. Cl. 349/151; 349/187

(57) ABSTRACT

A liquid crystal display device includes a first substrate where a pixel thin film transistor is formed, a second substrate which is positioned opposite to the first substrate and a liquid crystal layer interposed between the first substrate and the second substrate. A light source is positioned beneath the first substrate, and joins the first substrate with the second substrate, the first substrate comprising: a first insulating substrate which has a display area where the pixel thin film transistor is formed and a non-display area which surrounds the display area; a gate line in the display area and the gate line being electrically connected to the pixel thin film transistor. A gate driving portion is formed in the non-display area to drive the gate line and comprises a driving thin film transistor; and a light blocking member which covers the gate driving part.

### CROSS-REFERENCE TO RELATED APPLICATIONS

This application claims priority from Korean Patent Application No. 10-2006-0116531, filed on Nov. 23, 2006 in the Korean Intellectual Property Office, the disclosure of which is incorporated herein by reference.

### BACKGROUND OF INVENTION

1. Field of Invention

Apparatuses and methods consistent with the present invention relate to a liquid crystal display device and a manufacturing method of the liquid crystal display device.

2. Description of the Related Art

A liquid crystal display device comprises a liquid crystal display (LCD) panel and a backlight unit. The LCD panel comprises a first substrate having thin film transistors (TFT), a second substrate opposite to correspond to the first substrate, and a liquid crystal layer which is disposed between the first substrate and the second substrate. Since the LCD panel does not emit light by itself, it is supplied with the light from the backlight unit which is provided in back of the first substrate.

A gate line, a data line, and the TFT which is connected to the lines are formed on the first substrate. Each pixel is connected to the TFT to be controlled independently.

A gate driving part and a data driving part are required to drive the gate line and the data line. A method by which the gate driving part is directly formed on the first substrate is used to save cost of the driving part.

The gate driving part comprises a plurality of TFT. The TFT changes its characteristic by the light. However, if the characteristic of the TFT is changed, the gate line is driven unstably.

### SUMMARY OF THE INVENTION

Accordingly, it is an aspect of the present invention to provide a liquid crystal display device where a gate line is driven stably.

Another aspect of the present invention is to provide a manufacturing method of the liquid crystal display device where the gate line is driven stably.

Additional aspects of the present invention are set forth in the description which follows.

The foregoing and/or other aspects of the present invention can be achieved by providing a liquid crystal display device comprising: a first substrate where a pixel thin film transistor is formed; a second substrate which is positioned opposite to the first substrate; a liquid crystal layer which is positioned between the first substrate and the second substrate; a light source which is positioned in back of the first substrate; and a sealant which joins the first substrate with the second substrate, the first substrate comprising: a first insulating substrate which has a display area where the pixel thin film transistor is formed and a non-display area which surrounds the display area; a gate line which is formed in the display area and electrically connected to the pixel thin film transistor; a gate driving part which is formed in the non-display area to drive the gate line and comprises a driving thin film transistor; and a light blocking member which covers the gate driving part.

According to an aspect of the invention, the first substrate further comprises an inner black matrix which is formed in the display area and an outer black matrix which is formed in the non-display area, and the light blocking member comprises the outer black matrix.

According to an aspect of the invention, the first substrate further comprises a color filter which is formed on the display area.

According to an aspect of the invention, the second substrate comprises a second insulating substrate and a common electrode, the second insulating substrate and the common electrode being directly contacted with each other.

According to an aspect of the invention, the second insulating substrate comprises plastics.

According to an aspect of the invention, the pixel thin film transistor comprises an amorphous silicon layer.

According to an aspect of the invention, at least a part of the sealant faces the light shutting member.

According to an aspect of the invention, the first substrate further comprises a planarization layer which is formed on the light shutting member, and the sealant is positioned between the planarization layer and the second substrate.

According to an aspect of the invention, the gate driving part comprises a first gate driving part and the second gate driving part, the display area is positioned between the first gate driving part and the second driving part, and the gate line is connected in turn to the first gate driving part and the second gate driving part.

According to an aspect of the invention, the first substrate further comprises a data line which intersects with the gate line and is electrically connected to the pixel thin film transistor, and a pixel electrode which is electrically connected to the pixel thin film transistor, the pixel electrode comprising a first pixel electrode, a second pixel electrode and a third pixel electrode which constitute a single pixel, and the first pixel electrode, the second pixel electrode and the third pixel electrode being connected to different gate lines.

According to an aspect of the invention, two of the first pixel electrode, the second pixel electrode and the third pixel electrode are connected to the same data line, and the first pixel electrode, the second pixel electrode and the third pixel electrode extend in an extending direction of the gate line.

According to an aspect of the invention, the first pixel electrode, the second pixel electrode and the third pixel electrode are driven in turn.

The foregoing and/or other aspects of the present invention can be achieved by providing a liquid crystal display device comprising: a first substrate which comprises a first insulating substrate, a pixel electrode which is formed in a display area of the first insulating substrate, a gate driving part which is formed in a non-display area of the first insulating substrate and comprises a driving thin film transistor, and a black organic material layer which covers the gate driving part; a second substrate which is positioned opposite to the first substrate; a sealant which is positioned between the first substrate and the second substrate; and a liquid crystal layer which is positioned at a space surrounded by the first substrate, the second substrate and the sealant.

According to an aspect of the invention, the first substrate comprises an inner black matrix which is formed in the display area, and an outer black matrix which is formed in the non-display area, and the black organic material layer comprises the outer black matrix.

According to an aspect of the invention, the first substrate further comprises a color filter which is formed on the display area.

According to an aspect of the invention, the second substrate comprises a second insulating substrate and a common electrode, the second insulating substrate and the common electrode being directly contacted with each other.

The foregoing and/or other aspects of the present invention can be achieved by providing a manufacturing method of a liquid crystal display device, the manufacturing method comprising: providing a first substrate comprising a first insulating substrate, a pixel electrode which is formed in a display area of the first insulating substrate, a gate driving part which is formed in a non-display area of the first insulating substrate and comprises a driving thin film transistor, and a black organic material layer which covers the gate driving part; providing a second substrate comprising a second insulating substrate and a common electrode which is formed on the second insulating substrate; forming a sealant on one of the first substrate and the second substrate; disposing the other one of the first substrate and the second substrate on the sealant; and hardening the sealant by applying an ultra violet ray from an upper side of the second substrate to the sealant.

According to an aspect of the invention, the manufacturing method of a liquid crystal display device further comprises forming a liquid crystal layer at a space which is surrounded by the first substrate, the second substrate and the sealant.

According to an aspect of the invention, the second insulating substrate is directly contacted with the common electrode.

### BRIEF DESCRIPTION OF THE DRAWINGS

The above and/or other aspects of the present invention will become apparent and more readily appreciated from the following description of the exemplary embodiments, taken in conjunction with the accompanying drawings, in which:

FIG. 1 and FIG. 2 are arrangement plan views of a liquid crystal display device according to a first exemplary embodiment of the present invention.

FIG. 3 is an enlarged view of region “A” shown in FIG. 1.

FIG. 4 is a sectional view, taken along line IV-IV in FIG. 1.

FIG. 5 is an enlarged view of the dashed line region indicated by reference character “C” in FIG. 4.

FIG. 6 is an enlarged view of gate driver 123 shown in the dashed line region indicated by reference character “B” in FIG. 3.

FIG. 7A to FIG. 7D are views useful for explaining a manufacturing method of the liquid crystal display device according to the first exemplary embodiment of the present invention.

FIG. 8 is a perspective view useful for explaining another manufacturing method of the liquid crystal display device according to the first exemplary embodiment of the present invention.

FIG. 9 to FIG. 12 are sectional views of liquid crystal display devices according to a second to a fifth exemplary embodiments of the present invention.

FIG. 13 is a plan view of a liquid crystal display device according to a sixth exemplary embodiment of the present invention.

FIG. 14 is plan view illustrating a driving technique for a liquid crystal display device according to the sixth exemplary embodiment of the present invention.

FIG. 15 is a sectional view of a liquid crystal display device according to the sixth exemplary embodiment of the present invention.

### DETAILED DESCRIPTION OF EXEMPLARY EMBODIMENTS OF THE INVENTION

Reference is now made in detail to the embodiments of the present invention, examples of which are illustrated in the accompanying drawings, wherein like reference numerals refer to like elements throughout. The embodiments described below explain the present invention by referring to the figures. The same elements may be representatively described in detail in a first exemplary embodiment of the present invention, thus may not be described in other exemplary embodiments.

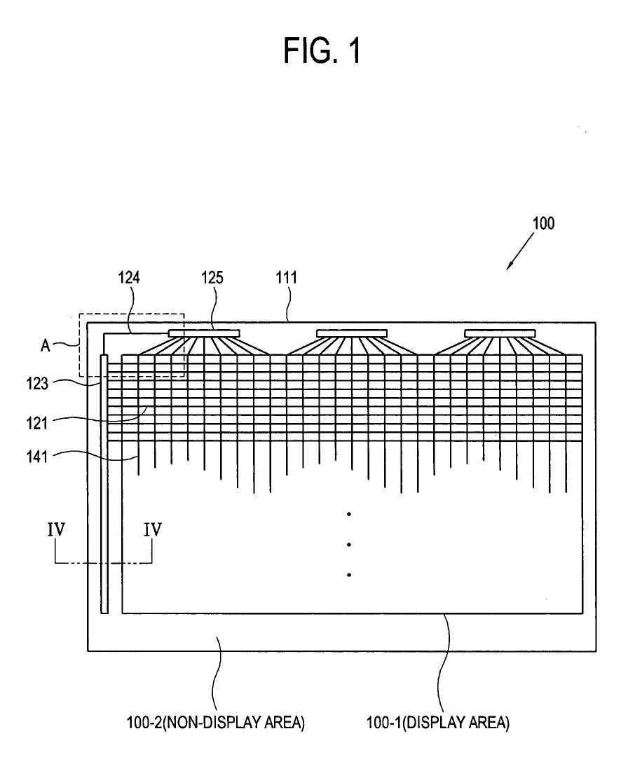

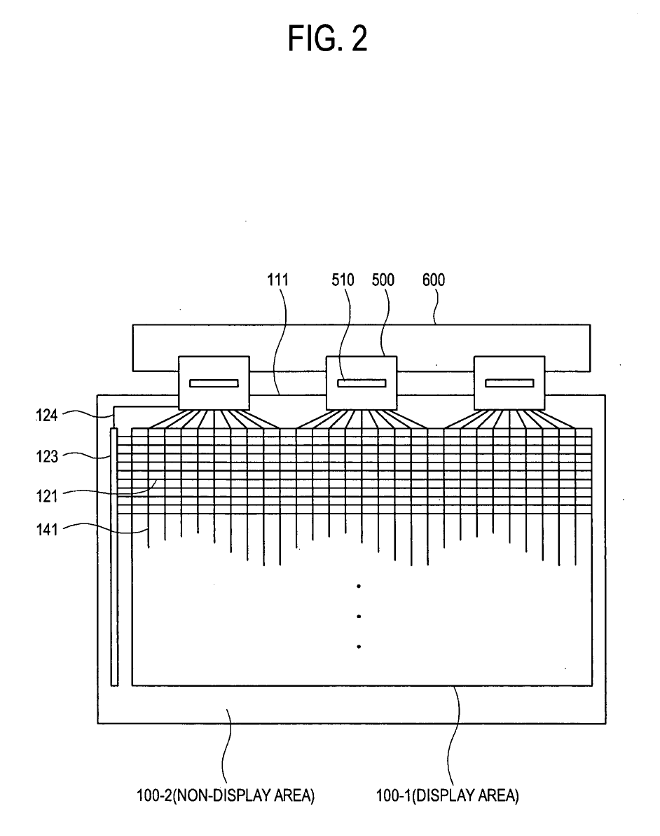

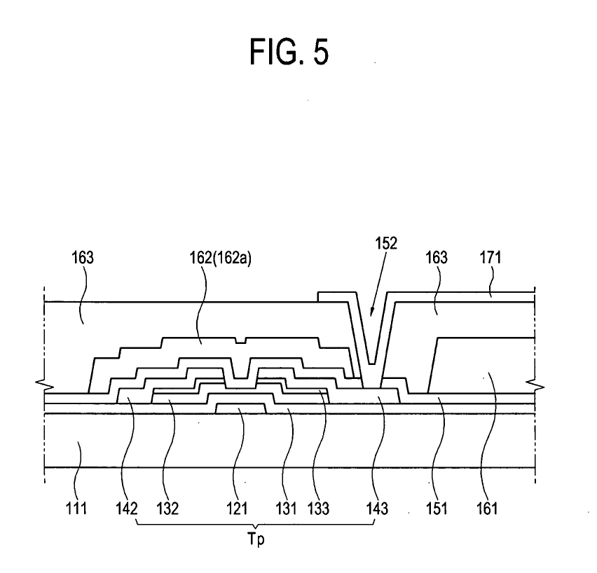

A liquid crystal display device according to a first exemplary embodiment of the present invention is described with reference to FIG. 1 to FIG. 6. FIG. 1 shows only a first substrate 100 and excludes a flexible member 500 and a circuit substrate 600 shown in FIG. 2.

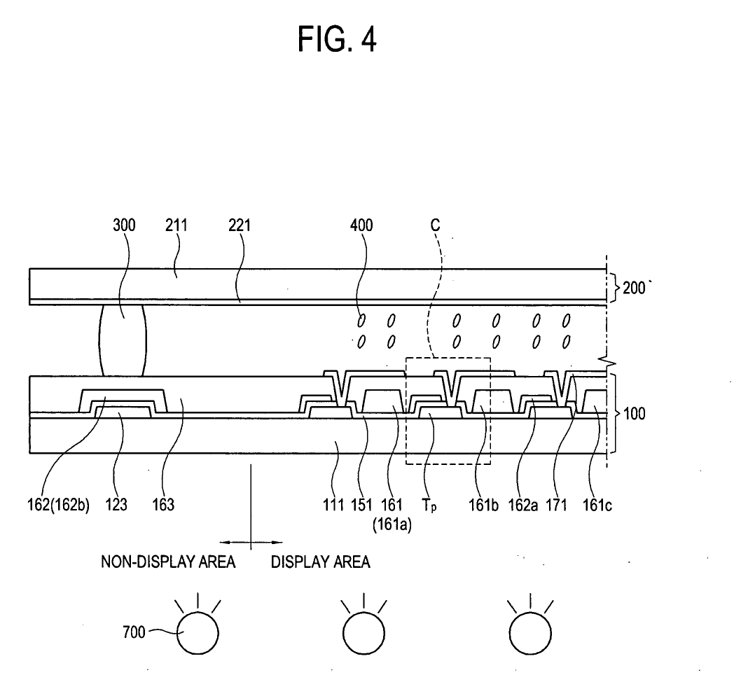

As shown in FIG. 4, the liquid crystal display device 1 according to the present invention comprises the first substrate 100 having a pixel thin film transistor Tp, a second substrate 200 opposite to the first substrate 100, a sealant 300 which joins the first substrate 100 and the second substrate 200, a liquid crystal layer 400 which is surrounded by the substrates 100 and 200 and the sealant 300, and a light source 700 which is placed below the first substrate 100.

As shown in FIG. 2, the first substrate 100 is connected with a flexible member 500, and the flexible member 500 is connected to the circuit substrate 600.

Although not shown in the figures, the liquid crystal display device 1 may further comprise an optical member between the first substrate 100 and the light source 700. The optical member may comprise a prism film, a diffusion film, a diffusion plate, a reflective polarizing film or a protection film.

The first substrate 100 is divided into a display area 100-1 and a non-display area 100-2 which surrounds the display area.

Display area 100-1 is described more fully below.

Gate wiring 121 and 122 are formed on a first insulating substrate 111. The gate wiring 121 and 122 may be a single metal layer or a multiple metal layer. The gate wiring 121 and 122 comprise a gate line 121 extending horizontally and a gate electrode 122 which is connected to the gate line 121.

Although not shown in the figures, the gate wiring 121 and 122 may further comprise a storage electrode line which forms a storage capacitor by being superposed with a pixel electrode 171.

The gate wiring 121 and 122 are covered by a gate insulating film 131 which comprises silicon nitride (SiNx) or similar material.

A semiconductor layer 132 which comprises amorphous silicon, or other semiconductor material known in the art, is formed on the gate dielectric film 131 corresponding to the gate electrode 122. An ohmic contact layer 133, which comprises silicide or n+ hydrogenation amorphous silicon heavily doped with n type impurities or other known in the art, is formed on the semiconductor layer 132. The ohmic contact layer 133 is divided into two separate parts.

Data wiring 141, 142 and 143 are formed on the ohmic contact layer 133 and the gate insulating film 131. The data wiring 141, 142 and 143 may also be a single metal layer or a multiple metal layer. The data wiring 141, 142 and 143 comprise a data line 141 which extends vertically to intersect with the gate line 121, a source electrode 142 which is a branch of the data line 141 and partly extends to an upper part of the ohmic contact layer 133, and a drain electrode 143 which is separate from the source electrode 142 and partly formed on the ohmic contact layer 133.

A passivation film 151, which comprises silicon nitride or other materials known in the art, is formed on the data wiring 141, 142 and 143 and on the semiconductor layer 132 which the data wiring 141, 142 and 143 do not cover. The passivation film 151 has a contact hole 152 which exposes the drain electrode 143.

A color filter 161 is formed on the passivation film 151. The color filter 161 is positioned between the pixel thin film transistors Tp. The color filter 161 comprises three sub-color filters 161a, 161b and 161c which have different colors.

An inner black matrix 162a is formed on the passivation film 151 which is positioned on the pixel thin film transistor Tp. Although not shown in figures, the inner black matrix 162a may also be formed on the passivation film 151 which is positioned on the gate line 121, and/or on the passivation film 151 which is positioned on the data line 141.

The inner black matrix 162a prevents an outer light from entering the semiconductor layer 132 of the pixel thin film transistor Tp.

A planarization layer 163 is formed on the inner black matrix 162a and the color filter 161. The planarization layer 163 is removed at a contact hole 152.

The planarization layer 163 may be made of a material, whose dielectric constant is less than 4, such as SiOF, SiOC, an organic material or other known in the art. SiOF and SiOC may be formed by using plasma enhanced chemical vapor deposition (PECVD). The organic material layer may be formed by using spin coating, slit coating or other method known in the art. The organic material may be one of benzocyclobutene (BCB) series, olefin series, acrylic resin series, polyimide series and fluororesin. The planarization layer 163 may be made of a photoresist organic insulating material.

A pixel electrode 171 is formed on the planarization layer 163. The pixel electrode 171 is made of a transparent conductive material such as indium tin oxide (ITO), indium zinc oxide (IZO) or other known in the art.

The pixel electrode 171, which is made of the transparent conductive material, is connected with the pixel thin film transistor Tp through the contact hole 152.

The non-display area of the first substrate 100 is described below.

A gate driver 123 is formed within the non-display area 100-2 at the left side of the display area to drive the gate line 121. The gate driver 123 is formed simultaneously with the pixel thin film transistor Tp and is also sometimes referred to as a shift register.

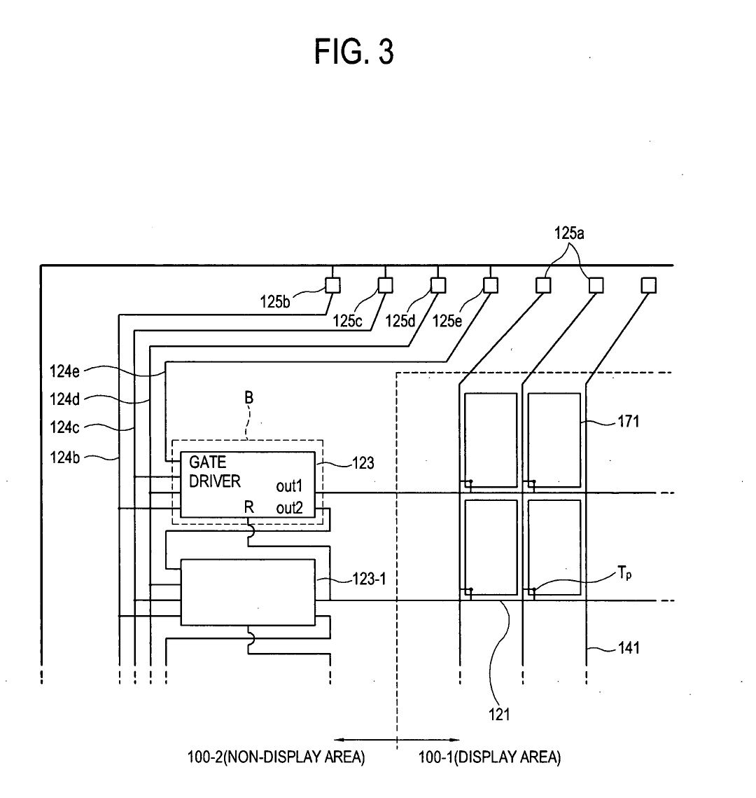

As shown in FIG. 2 and FIG. 3, the gate driver 123 receives a gate driving signal from the circuit substrate 600 through the flexible member 500, a pad part 125 and a gate connecting wiring 124. The received gate driving signal includes a first clock signal CKV which is a gate-on voltage, a second clock signal CKVB whose phase is opposite to that of the first clock signal, a scan start signal STVP, a gate-off voltage Voff, and other known in the art.

The pad part 125 comprises a data pad 125a for receiving data signal, and signal pads 125b to 125e for receiving a gate signal. The signal pads 125b to 125e for receiving the gate signal receive the gate-off voltage Voff, the first clock signal CKV, the second clock signal CKVB and the scan start signal STVP respectively.

The gate connecting wiring 124 comprises a plurality of sub-connection wiring 124b to 124e which are connected to the signal pads 125b to 125e respectively.

A first gate driver 123 which is connected to a first gate line 121 is synchronized to the scan start signal and the clock signal and starts outputting the gate-on voltage. A second and remaining drivers 123-1 and subsequent ones are synchronized to the output voltage of the previous gate driver 123 and the clock signal and start outputting the gate-on voltage. An end point of outputting the gate-on voltage in each gate driver 123 is closely related to a start point of the outputting the gate-on voltage in the latter gate driver 123.

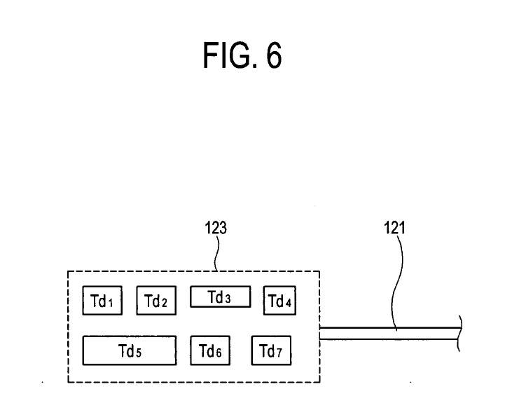

As shown in FIG. 6, a plurality of driving thin film transistors Td1-Td7 are formed in the gate driver part 123. A structure of the driving thin film transistor Td is similar to that of pixel thin film transistor Tp.

The gate driver 123 is covered by an outer black matrix 162b. The inner black matrix 162a and the outer black matrix 162b are formed at the same time and comprise photoresist organic material containing black pigment. The black pigment may be carbon black or titanium oxide.

Second substrate 200 is described below with reference to FIG. 4.

The second substrate 200 comprises a second insulating substrate 211 and a common electrode 221 which is formed on the entire surface of the second insulating substrate 211. The common electrode 221 and the second insulating substrate 211 are in direct contact.

The second insulating substrate 211 is comprised of a plastic material of a type well known to those in the LCD display field. More particularly suitable plastic materials include, but are not limited to, polycarbonate, polyimide, polyether sulfone (PES), polyarylate (PAR), poly ethylene naphthalate (PEN), poly ethylene terephthalate (PET) or other known in the art. The second insulating substrate 211 may be provided to be thinner than the first insulating substrate 111.

The common electrode 221 can comprise materials such as a transparent conductive material such as indium tin oxide (ITO), indium zinc oxide (IZO) and other materials known in the art.

The sealant 300 joins the first substrate 100 with the second substrate 200 and is positioned above the outer black matrix 162b.

The sealant 300 comprises an amine-based hardener whose main components are epoxy resin and acryl resin, a filler such as a alumina powder, and a solvent such as propylene-glycol-diacetate. The sealant 300 determines a distance between both substrates 100 and 200. A spacer (not shown) which is made of glass or plastics may be positioned in the sealant 300.

The light source 700 may be a surface light source, a lamp or a light-emitting diode. The lamp may be a cold cathode fluorescent lamp or an external electrode fluorescent lamp.

In the first exemplary embodiment described above, the semiconductor layer of the driving thin film transistor Td comprises an amorphous silicon like the pixel thin film transistor Tp. If the amorphous silicon receives light, it becomes unstable, increases a current Ion of the driving thin film transistor, and increases electric power consumption. On the other hand, the present invention may also be applied in case that the semiconductor layer comprises polysilicon.

According to the first exemplary embodiment of the present invention, the semiconductor layer of the gate driver 123 does not receive a light from the outside and a light from the light source 700. The light from the outside is absorbed by the outer black matrix 162a, which covers the gate driver 123. The light from the light source 700 toward the semiconductor layer is blocked by the gate electrode of the driving thin film transistor Td. Among the light from the light source 700, the light which enters between a metal pattern of the gate driving parts 123 is absorbed by the outer black matrix 162b.

Therefore, according to the first exemplary embodiment of the present invention, the driving thin film transistor Td is stable and the gate line 121 may be driven stably. Also, the electric power consumption may be decreased.

Since the outer black matrix 162b is covered by the planarization layer 163, the liquid crystal layer 400 does not directly contact with the outer black matrix 162b. Accordingly, the liquid crystal layer 400 may not be contaminated by the outer black matrix 162b.

According to the first exemplary embodiment of the present invention, both of the color filter 161 and the black matrix 162 are formed on the first substrate 100. However, only the common electrode 221 is formed on the second substrate 200. Therefore, aligning the first substrate 100 and the second substrate 200 may be simple in a manufacturing process thus saving overall manufacturing cost. Also, the second insulating substrate 211 may comprise plastics to decrease weight and thickness of the liquid crystal display device 1.

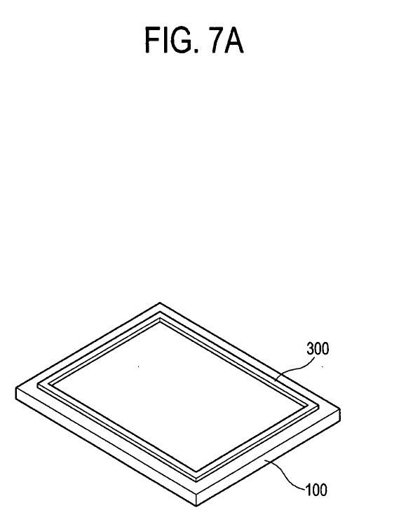

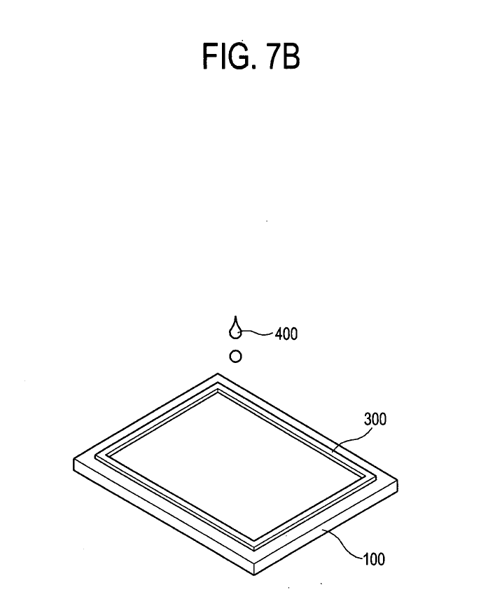

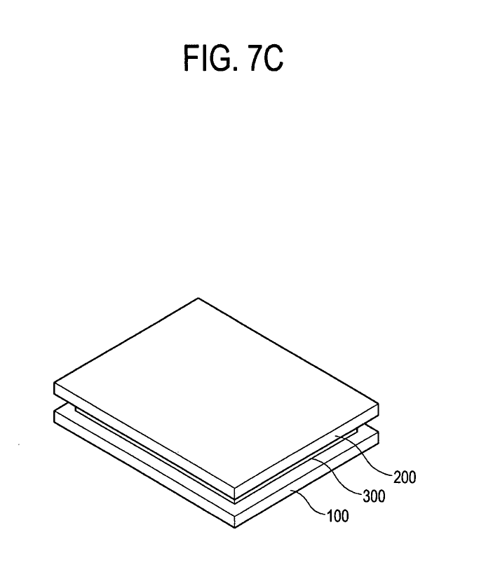

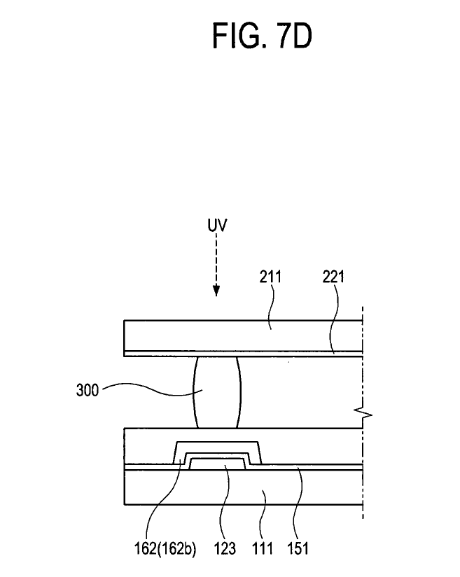

Hereinafter, a manufacturing method of the liquid crystal display device according to the first exemplary embodiment of the present invention is described with reference to FIG. 7A to FIG. 7D.

Firstly, the first substrate 100 is provided as shown in FIG. 7A, and the sealant 300 is formed on the first substrate 100.

The first substrate 100 and the second substrate 200 shown is FIG. 7C may be provided by a conventional method, and the sealant 300 may be formed by drawing method using a dispenser. The sealant 300 is formed to have a shape of a rectangular.

Then, as shown in FIG. 7B, the liquid crystal layer 400 is formed by dropping method. Dropping the liquid crystal layer 400 may be performed by using one-drop method where the liquid crystal layer 400 may be formed by only one dropping to reduce manufacturing time.

Then, as shown in FIG. 7C, the second substrate 200 is positioned on the sealant 300. In this process, the first substrate 100 and the second substrate 200 need not be arrayed accurately because there is no pattern such as the color filter or the black matrix on the second substrate 200.

Then, as shown in FIG. 7D, an ultra violet ray is applied from an upper side of the second substrate 200 to harden the sealant 300. Though the ultra violet ray is applied from the upper side of the second substrate 200, gate driver 123 may not be damaged by the ultra violet ray because the outer black matrix 162b blocks the ultra violet ray.

On the other hand, as the ultra violet ray is applied uniformly onto the whole sealant 300 through the second substrate 200, the sealant 300 may be hardened uniformly within short time.

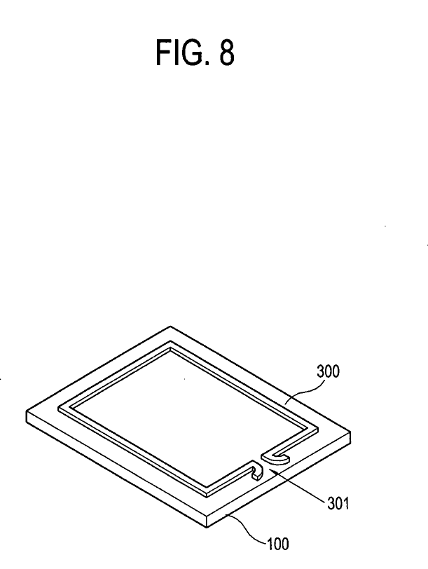

Another manufacturing method of the liquid crystal display device according to the first exemplary embodiment of the present invention is described below with reference to FIG. 8.

The first substrate 100 and the second substrate 200 are provided, and the sealant 300 is formed on the first substrate 100 or the second substrate 200. The sealant 300 has a shape of the rectangle, however an opening 301 is formed.

After the sealant 300 is formed, both substrates 100 and 200 are joined together and the liquid crystal is injected between both substrates 100 and 200. The liquid crystal is injected by filling method where the liquid crystal is preferably but not necessarily injected while a space between both substrates 100 and 200 is made to be a vacuum.

If injection of the liquid crystal is finished, the opening 301 is closed by an additional sealant.

Also, in the manufacturing method described in FIG. 8, as the ultra violet ray is applied uniformly onto the whole sealant 300 through the second substrate 200, the sealant 300 may be hardened uniformly within short time.

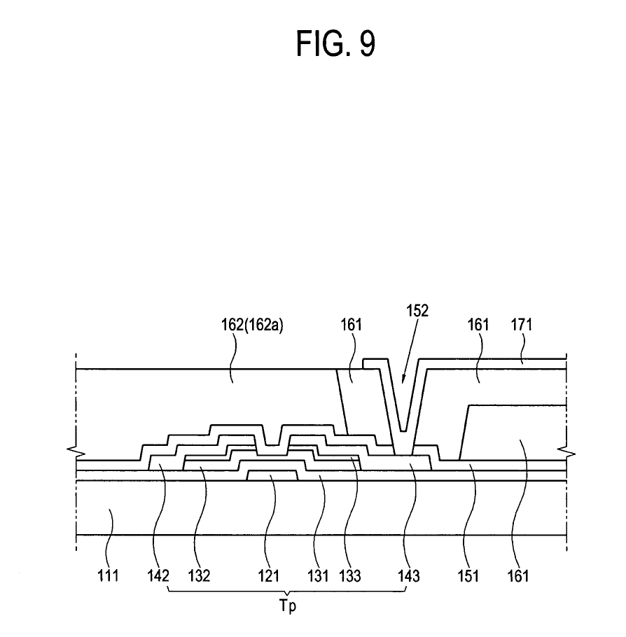

A second exemplary embodiment of the present invention is described with reference to FIG. 9.

As shown in FIG. 9, the black matrix 162 and the color filter 161 are formed to have the same height. According to the second exemplary embodiment, the planarization layer 163 in the first exemplary embodiment is omitted thus making the overall manufacturing process simple.

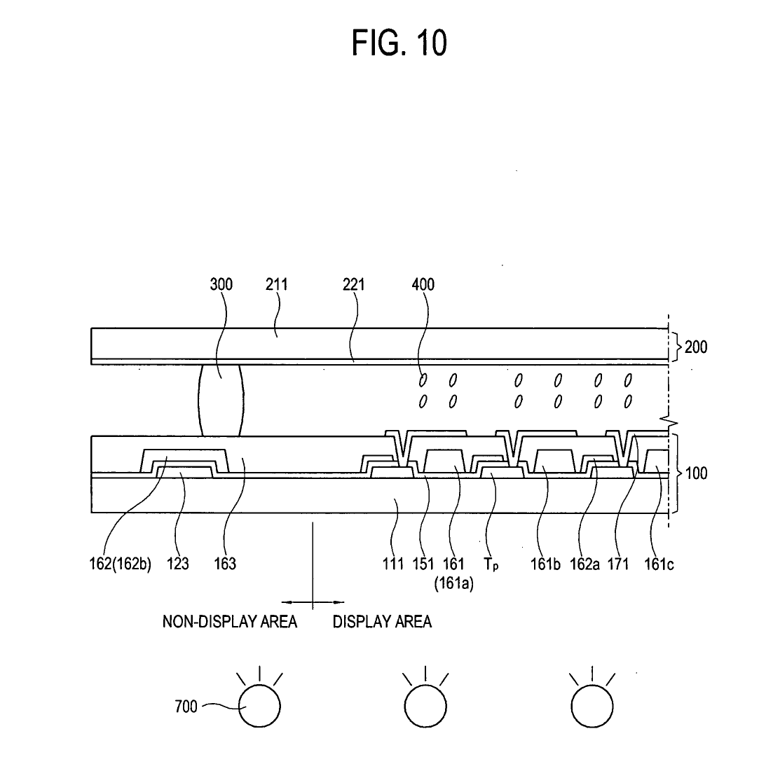

A third exemplary embodiment of the present invention is described with reference to FIG. 10.

As shown in FIG. 10, the sealant 300 partially faces the outer black matrix 162b.

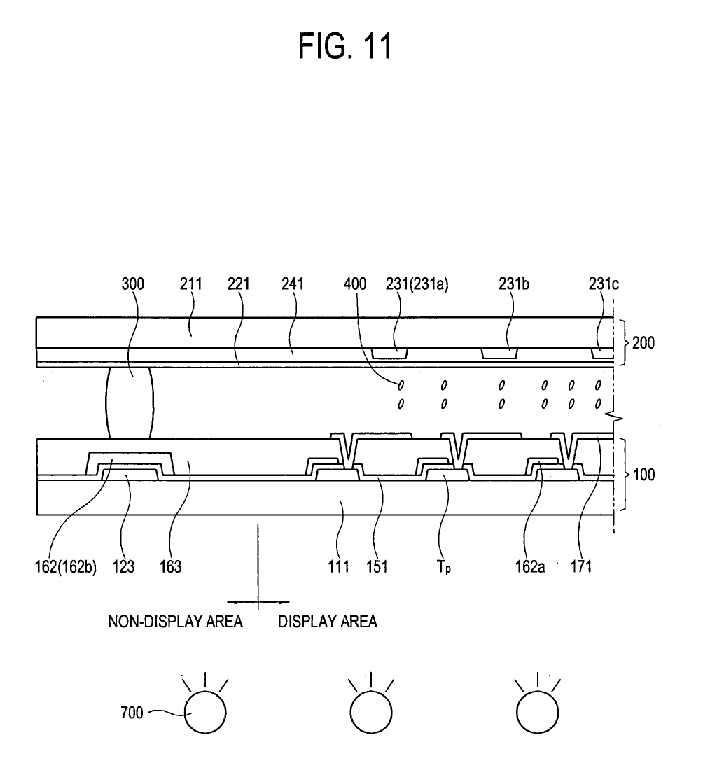

A fourth exemplary embodiment of the present invention is described with reference to FIG. 11.

As shown in FIG. 11, a color filter 231 is formed on the second insulating substrate 211. The color filter 231 is covered by an over coat layer 241. The color filter 231 comprises a plurality of sub-layers 231a, 231b and 231c which have different colors.

The common electrode 221 is formed on the over coat layer 241.

In another exemplary embodiment, the second substrate 200 may comprise the black matrix. In this case, the inner black matrix 162a of the first substrate 100 is not formed.

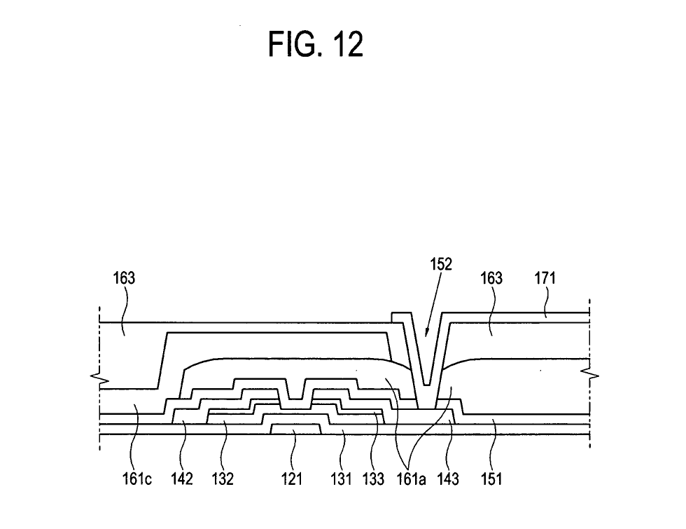

A fifth exemplary embodiment of the present invention is described with reference to FIG. 12.

As shown in FIG. 12, two color filter sub-layers 161a and 161c are formed on the pixel thin film transistor Tp, however the inner black matrix 162a is not formed. The light from the outside to enter the semiconductor layer 132 of the pixel thin film transistor Tp is absorbed by the two color filter sub-layers 161a and 161c. Although not shown in the figures, two of the three color filter sub-layers 161a, 161b and 161c are also formed to be overlapped on the gate line 121 and/or the data line 141.

In another exemplary embodiment, all three color filter sub-layers 161a, 161b and 161c are formed to be overlapped on the pixel thin film transistor Tp, the gate line 121 and/or the data line 141.

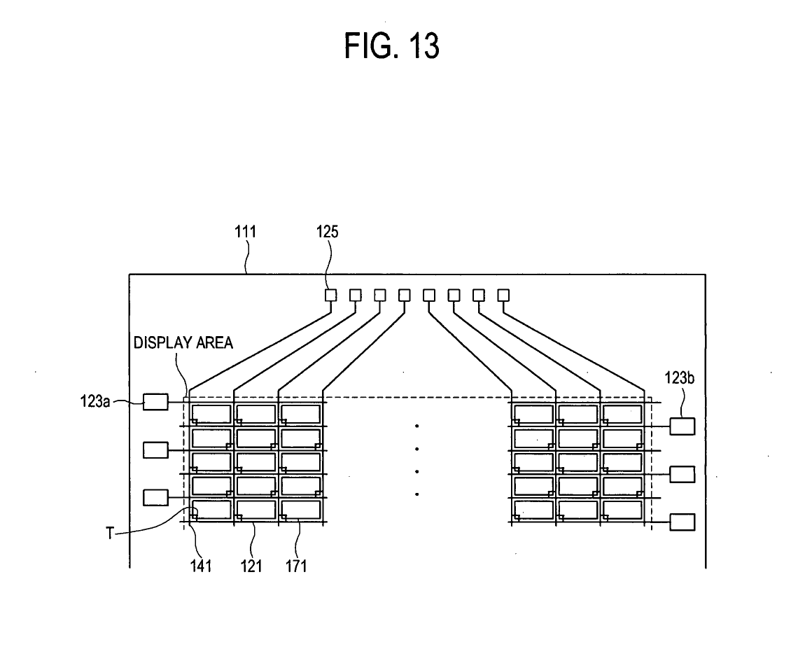

Hereinafter, a sixth exemplary embodiment of the present invention is described with reference to FIG. 13 to FIG. 15.

The pixel electrode 171 has a shape of a rectangle which extends in an extending direction of the gate line 121.

The three pixel electrodes 171 which are disposed adjacently therebetween in an extending direction of the data line 141 constitute one pixel. Each pixel electrode 171 constituting one pixel is connected to the different gate lines 121. The pixel electrode 171 is connected in turn to the data line 141 at its left side and to the data line 141 at its right side along the extending direction of the data line 141.

In the liquid crystal display device according to the first exemplary embodiment of the present invention, three pixel electrodes 171 constituting one pixel are disposed in the extending direction of the gate line 121, and each pixel electrode 171 is connected to the different data lines 141. According to the sixth exemplary embodiment, to realize the same number of the pixels, the number of the gate lines 121 is increased to three times as many as that of the conventional ones and the number of the data lines 141 is decreased to a third of that of the conventional ones.

The gate driver 123 comprises a first gate driver 123a which is formed in the non-display area at the left side of the display area, and a second gate driver 123b which is formed in the non-display area at the right side of the display area.

Referring to FIG. 13, the gate line 121 at odd number is connected to the first gate driver 123a, and the gate line 121 at even number is connected to the second gate driver 123b.

Generally, a circuit for driving the data line 141 is more complicated and more expensive than a circuit for driving the gate line 121. According to the present invention, as the number of the data lines 141 is decreased to a third of that of the conventional ones, the number of the circuits for driving the data lines 141 is decreased, so that the overall manufacturing cost can be decreased.

Unlike the data line 141, the number of the gate lines 121 is increased to three times of that of the conventional ones, so that the cost of the circuits for driving the gate lines 121 may be increased. However, according to the present invention, as the gate line 121 is driven by using the gate driver 123 which is formed on the first insulating substrate 111, the cost of the circuits is not increased.

On the other hand, the pixel electrode 171 extends in the extending direction of the gate line 121, so that the distance between adjacent gate lines 121 is made to be decreased. Accordingly, a space for forming the gate driver 123 is restricted. However, according to the present invention, as the gate driver 123 is provided in part at each side of the display area, the space may be easily obtained.

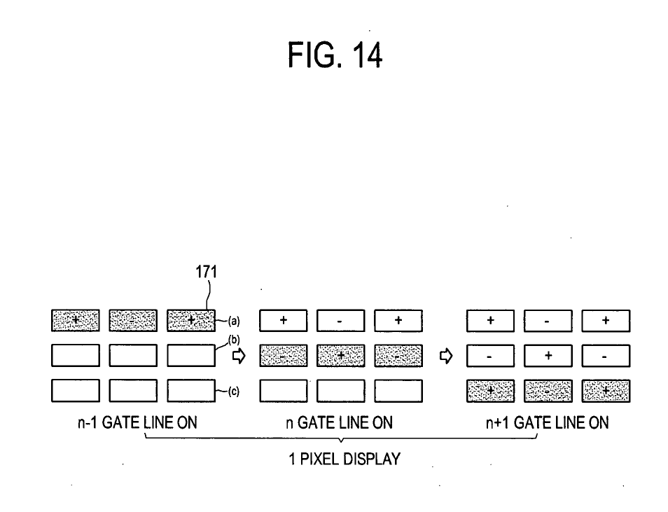

The driving of the liquid crystal display device 1 is described with reference to FIG. 14.

If the gate-on voltage is supplied to the gate line 121 at number (n−1), the pixel thin film transistor Tp which is connected thereto is ON. Accordingly, the pixel electrode 171 at line (a) which is connected to the gate line 121 at number (n−1) is ON.

Then, the gate-on voltage is supplied to the gate line 121 at number (n). Accordingly, the pixel electrode 171 at line (b) which is connected to the gate line 121 at number (n) is ON.

Likewise, if the gate-on voltage is supplied to the gate line 121 at number (n+1), the pixel electrode 171 at line (c) is ON, and thus completing displaying one pixel. Three gate lines 121 are driven sequentially to display one pixel, and the data line 141 supplies the data voltage, which corresponds to each pixel electrode 171, according to the driving of the gate line 121.

In this case, the polarity of the voltage applied to the pixel electrode 171 is controlled to be dot inversed.

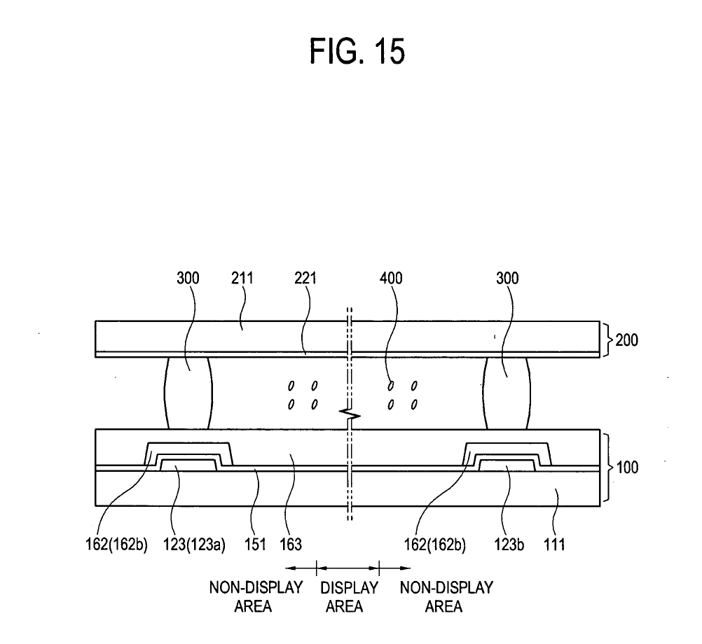

As shown in FIG. 15, the outer black matrix 162b covers both of the first gate driver 123a and the second gate driver 123b. Therefore, the gate driver 123 is not unstable by the light from the outside or the light from the light source 700.

According to the sixth exemplary embodiment, the electric power consumption of the gate driver 123 is more than that in the first exemplary embodiment. However, the gate driver 123 is stable by the outer black matrix 162b, thus preventing the increase of the electric power consumption.

As described above, according to the present invention, the liquid crystal display device where the gate line is driven stably is provided.

Also, according to the present invention, the manufacturing method of the liquid crystal display device where the gate line is driven stably is provided.

Although a few exemplary embodiments of the present invention have been shown and described, it will be appreciated by those skilled in the art that changes may be made in these embodiments without departing from the principles and spirit of the invention, the scope of which is defined in the appended claims and their equivalents.

What is claimed is:

1. A liquid crystal display device comprising:
a first substrate having at least one pixel thin film transistor;
a second substrate positioned in a spaced apart relationship to the first substrate;
a liquid crystal layer interposed between the first substrate and the second substrate;
a light source which positioned on a side of the first substrate opposite the second substrate, wherein the first substrate comprising: a first insulating substrate which has a display area where the pixel thin film transistor is formed and a non-display area which surrounds the display area;
a gate line formed in the display area and electrically connected to the pixel thin film transistor;
a gate driver formed in the non-display area and coupled to drive the gate line, the gate driver comprising a driving thin film transistor; and
a light blocking member which covers the gatedriver.

2. The liquid crystal display device according to claim 1, wherein the first substrate further comprises an inner black matrix formed in the display area and an outer black matrix formed in the non-display area, and the light blocking member comprises the outer black matrix.

3. The liquid crystal display device according to claim 2, wherein the first substrate further comprises a color filter formed in the display area.

4. The liquid crystal display device according to claim 3, wherein the second substrate comprises a second insulating substrate and a common electrode, and further wherein the common electrode directly contacts the second insulating substrate.

5. The liquid crystal display device according to claim 1, wherein the second insulating substrate is comprised of a plastic material.

6. The liquid crystal display device according to claim 1, wherein the pixel thin film transistor comprises an amorphous silicon layer.

7. The liquid crystal display device according to claim 1, further comprising a sealant interposed between the first substrate and the second substrate, wherein at least a portion of the sealant is aligned with the light blocking member.

8. The liquid crystal display device according to claim 7, wherein the first substrate further comprises a planarization layer formed on the light blocking member, and wherein the sealant is positioned between the planarization layer and the second substrate.

9. The liquid crystal display device according to claim 1, wherein the gate driver comprises a first gate driving portion and the second gate driving portion, the display area is positioned between the first gate driving portion and the second driving portion, and the gate line is connected to the first gate driving portion and the second gate driving portion.

10. The liquid crystal display device according to claim 9, wherein the first substrate further comprises a data line which is electrically connected to the pixel thin film transistor, and a pixel electrode which is electrically connected to the pixel thin film transistor,
wherein the pixel electrode comprises a first pixel electrode portion, a second pixel electrode portion and a third pixel electrode portion, and further wherein the first pixel electrode portion, the second pixel electrode portion and the third pixel electrode portion are connected to different gate lines.

11. The liquid crystal display device according to claim 10, wherein two of the first pixel electrode portion, the second pixel electrode portion and the third pixel electrode portion are connected to the same data line, and
the first pixel electrode portion, the second pixel electrode portion and the third pixel electrode portion extend in a direction which is a direction of the gate line.

12. The liquid crystal display device according to claim 11, wherein the first pixel electrode, the second pixel electrode and the third pixel electrode are driven sequentially.

13. A liquid crystal display device comprising:
a first substrate which comprises a first insulating substrate, a pixel electrode which is formed in a display area of the first insulating substrate, a gate driving portion which is formed in a non-display area of the first insulating substrate and comprises a driving thin film transistor, and a black organic material layer which covers the gate driving part;
a second substrate which is positioned opposite to the first substrate;
a sealant which is interposed between the first substrate and the second substrate; and
a liquid crystal layer in a space defined by the first substrate, the second substrate and the sealant.

14. The liquid crystal display device according to claim 13, wherein the first substrate comprises an inner black matrix which is formed in the display area, and an outer black matrix which is formed in the non-display area, and
the black organic material layer comprises the outer black matrix.

15. The liquid crystal display device according to claim 14, wherein the first substrate further comprises a color filter formed on the display area.

16. The liquid crystal display device according to claim 14, wherein the second substrate comprises a second insulating substrate and a common electrode, and further wherein the common electrode directly contacts the second insulating substrate.

17. A manufacturing method of a liquid crystal display device, the manufacturing method comprising:
providing a first substrate comprising a first insulating substrate, a pixel electrode which is formed in a display area of the first insulating substrate, a gate driving part which is formed in a non-display area of the first insulating substrate and comprises a driving thin film transistor, and a black organic material layer which covers the gate driving part;
providing a second substrate comprising a second insulating substrate and a common electrode which is formed on the second insulating substrate;
forming a sealant on one of the first substrate and the second substrate;
disposing the other one of the first substrate and the second substrate on the sealant; and
hardening the sealant by applying an ultra violet ray from an upper side of the second substrate to the sealant.

18. The manufacturing method of a liquid crystal display device according to claim 17, further comprising forming a liquid crystal layer at a space which is surrounded by the first substrate, the second substrate and the sealant.

19. The manufacturing method of a liquid crystal display device according to claim 17, wherein the second insulating substrate is directly contacted with the common electrode.
